(19) United States
(12) Patent Application Publication
(10) Pub. No.: US 2009/0017286 A1
(43) Pub. Date: Jan. 15, 2009

(54) COPPER CLAD LAMINATE

(75) Inventors: Meguru Maeda, Nagoya (JP); Masahiro Oguni, Nagoya (JP); Kouichi Sawasaki, Nagoya (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. du Pont de Nemours and Company, Wilmington, DE (US)

(21) Appl. No.: 12/171,545

(22) Filed: Jul. 11, 2008

(30) Foreign Application Priority Data
Jul. 13, 2007 (JP) 2007-183774

(51) Int. Cl. B32B 15/08

(52) U.S. Cl. 428/323

(57) ABSTRACT

A copper clad laminate that is suited to use in high-performance flexible printed circuit boards, which meets both dimensional change and heat resistance requisites, has a small percent dimensional change after etching, and has properties that are applicable to AOI, and which further has excellent slickness (slip) and adhesion is provided. A copper clad laminate that uses a polyimide film that primarily uses paraphenylenediamine and 4,4′-diaminodiphenylether as diamine ingredients, and pyromellitic dianhydride and 3,3′,4,4′-biphenyltetracarboxylic dianhydride as acid dianhydride ingredients, which further has slip caused by producing surface protrusions by adding inorganic particles. One copper foil is adhered to one side of the polyimide film using an adhesive; and a second copper layer is directly adhered to the second side of the polyimide film.

### FIELD OF DISCLOSURE

This disclosure relates generally to copper clad laminates that are used in the field of electrical and electronic equipment and that are suitable for flexible printed circuit boards, chip on film (“COF”), tape automated bonding (“TAB”) and the like. More specifically the copper clad laminates of the present invention exhibit advantageous dimensional stability after etching and have a polyimide film substrate with a copper foil adhesively attached on one side, and a second copper foil attached on the other side by a means other than an adhesive.

### BACKGROUND OF THE DISCLOSURE

Copper clad laminates, with various types of polyimide film substrates, have been used for flexible printed circuit boards. Polyimide films, while flexible, can be problematic. If too soft, the substrate can warped during semiconductor mounting, causing poor joints. In addition, some conventional polyimide films can be problematic due to an unduly high coefficient of thermal expansion (CTE) or unduly high coefficient of hygroscopic expansion (CHE). Conventional polyimide films can also exhibit unwanted dimensional changes due to heat and water absorption, and if so, the desired wiring widths and wiring spacing can be difficult to achieve when forming intricate wiring patterns.

A need therefore exists for a copper clad laminate that is suited for use in high-performance flexible printed circuit boards, and: i. meets both dimensional change and heat resistance requisites; ii. has a relatively small percent dimensional change after etching, and iii. has properties that are applicable to automatic optical inspection (“AOI”), and iv. has useful slip and adhesion properties.

### SUMMARY

The present disclosure is directed to a copper clad laminate having a polyimide film with copper foil on both sides of the polyimide film. The polyimide film contains an aromatic diamine component and an aromatic dianhydride component. The aromatic diamine component is derived from i. 10-50 mol % paraphenylenediamine; and ii. 50-90 mol % 4,4′-diaminodiphenyl ether. The aromatic dianhydride component is derived from i. 50-99 mol % pyromellitic dianhydride; and ii. 1-50 mol % 3,3′,4,4′-biphenyl tetracarboxylic acid dianhydride. The polyimide film contains inorganic particles having a grain size of 0.01 μm to 1.5 μm, wherein the mean grain size is from 0.05 μm to 0.7 μm, and wherein inorganic particles-have a grain size distribution of at least 80% by volume. One copper foil is adhered to one side of the polyimide film using an adhesive; and a second copper layer is directly adhered to the second side of the polyimide film.

### DETAILED DESCRIPTION OF THE PREFERRED EMBODIMENTS

The present disclosure is directed to copper clad laminates that are well suited to high-performance flexible printed circuit boards, which have a low percent dimensional change after etching and are imbued with properties that are applicable to AOI, and which have excellent mobility (slip) and adhesion.

The copper clad laminates of this disclosure comprise a polyimide film as a substrate. A copper foil is adhered on one side of the polyimide film by means of an adhesive, and a copper layer is directly adhered to the second side of the polyimide film by means other than adhesive. The polyimide film comprises an aromatic diamine component and an aromatic dianhydride component. The aromatic diamine component is derived from i. 10-50 mol % paraphenylenediamine; and ii. 50-90 mol % 4,4′-diaminodiphenyl ether. The aromatic dianhydride component is derived from i. 50-99 mol % pyromellitic dianhydride; and ii. 1-50 mol % 3,3′,4,4′-biphenyl tetracarboxylic acid dianhydride. In one embodiment, the paraphenylenediamine is in range between and optionally including any two of the following mole %: 10, 15, 20, 25, 30, 35, 40, 45 and 50 mole % of total diamine. In one embodiment, the 4,4′-diaminodiphenyl ether is in range between and optionally including any two of the following mole %: 50, 55, 60, 65, 70, 75, 80, 85 and 90 mole % of total diamine. In one embodiment, the pyromellitic dianhydride is in range between and optionally including any two of the following mole %: 50, 55, 60, 65, 70, 75, 80, 85, 90, 92, 94, 96, 98 and 99 mole % of total dianhydride. In one embodiment, the 3,3′,4,4′-biphenyl tetracarboxylic acid dianhydride is in range between and optionally including any two of the following mole %: 1, 2, 4, 6, 8, 10, 15, 20, 25, 30, 35, 40, 45 and 50 mole % of total dianhydride.

The polyimide film contains inorganic particles. In some embodiments, the inorganic particles have a grain size between and optionally including any two of the following: 0.01, 0.05, 0.10, 0.15, 0.20, 0.25, 0.30, 0.35, 0.40, 0.45, 0.50, 0.55, 0.60, 0.66, 0.70, 0.75, 0.80, 0.85, 0.90, 0.95, 1.0, 1.2, 1.3, 1.4 and 1.5 μm. In some embodiments, the inorganic particles have a mean grain size between and optionally including any two of the following: 0.05, 0.10, 0.20, 0.30, 0.40, 0.50, 0.60, 0.70 μm. In some embodiments, at least 80% by volume of the inorganic particles have a (mean) grain size between and optionally including any two of the following: 0.15, 0.20, 0.25, 0.30, 0.35, 0.40, 0.45, 0.50, 0.55 and 0.60 μm. In some embodiments, the number of protrusions over 2 μm high occur 5 times or less in a area of 40 cm².

The copper clad laminate polyimide film has a thickness between and optionally including any two of the following: 5, 10, 15, 20, 25, 30, 35, 40, 45, 50, 55, 60, 65, 70, 75, 80, 85, 90, 95, 100, 110, 120, 130, 140, 150, 160, 170 and 175 μm. In some embodiments, the adhesive is selected from the group consisting of epoxy adhesive, acrylic adhesive, polyimide adhesive and combinations thereof. In some embodiments, copper foil on the adhesive side has a surface roughness between and optionally including any two of the following: 0.1, 0.2, 0.3, 0.4, 0.5, 0.6, 0.7, 0.8, 0.9 and 10 μm. In some embodiments, the copper clad laminate has a dimensional change after surface etching between and optionally including any two of the following: −0.100, −0.090, −0.080, −0.070, −0.060, −0.050, −0.040, −0.030, −0.020, −0.010, 0.010, 0.020, 0.030, 0.040, 0.050, 0.060, 0.070, 0.080, 0.090 and 0.100%.

The copper clad laminate of this disclosure uses a polyimide film as a substrate and possesses a copper laminate attached by means of an adhesive on one side and a copper laminate attached by means other than adhesive on the other side. The polyimide film used as the substrate in this disclosure is a polyimide film that is formed using paraphenylenediamine and 4,4′-diaminodiphenylether, as the diamine ingredients, and pyromellitic dianhydride and 3,3′,4,4′-biphenyltetracarboxylic dianhydride, as the acid dianhydride ingredients. In other words, the 4 necessary ingredients comprise paraphenylenediamine, 4,4′-diaminodiphenylether, pyromellitic dianhydride, and 3,3′,4,4′-biphenyltetracarboxylic dianhydride, and the polyimide film is obtained from only these 4, or from these 4 with small amounts of other ingredients added.

In some embodiments, the polyimide film is made using 10-50 mol % of paraphenylenediamine and 50˜90 mol % of 4,4′-diaminodiphenylether as the diamine ingredients, and 50˜99 mol % of pyromellitic dianhydride and 1˜50 mol % of 3,3′,4,4′-biphenyltetracarboxylic dianhydride as the acid dianhydride ingredients. More preferably, it is a polyimide film with a modulus of elasticity of 3˜7 GPA, coefficient of linear expansion of 5˜20 ppm/° C. at 50˜200° C., coefficient of hygroscopic expansion of 25 ppm/% RH or less, water absorbency of 3% or less, and heat shrinkage of 0.10% or less at 200° C.×1 hour. Since the aforementioned polyimide film is too hard if there is too much paraphenylenediamine and too soft if there is too little, it is preferable that this is 1˜70 mol %, more preferably 5˜60 mol %, and even more preferably 10˜50 mol %. Since it will be too soft if there is too much 4,4′-diaminodiphenylether and too hard if there is too little, it is preferable that this is 20˜99 mol %, more preferably 40˜95 mol %, and even more preferably 50˜90 mol %. Since it will be too hard if there is too much pyromellitic dianhydride and too soft if there is too little, it is preferable that this is 50˜99 mol %, more preferably 60˜90 mol %, and even more preferably 65˜85 mol %. Since it will be too soft if there is too much 3,3′,4,4′-biphenyltetracarboxylic dianhydride and too hard if there is too little, it is preferable that this is 1˜50 mol %, more preferably 10˜40 mol %, and even more preferably 15˜35 mol %.

In some embodiments, the modulus of elasticity, an index for the hardness of the polyimide film, is in the range of 3˜7 GPa, becoming too hard in excess of 7 GPa and too soft at lower than 3 GPa.

It is preferred that the coefficient of linear expansion is 5˜20 ppm/° C., with dimensional change due to heat becoming too great in excess of 20 ppm/° C. and with warping occurring due to the difference in coefficients of linear expansion with the metal used for wiring being too great if this is less than 5 ppm/° C. Since humidity-induced dimensional changes are too great if the coefficient of hygroscopic expansion exceeds 25 ppm/% RH, it is preferable that the coefficient of hygroscopic expansion is less than 25 ppm/% RH. Since the dimensional changes in the film due to the effects of absorbed water if the water absorbency exceeds 3%, it is preferable that the water absorbency is less than 3%. Since the dimensional change due to heat naturally increases if the heat shrinkage at 200°×1 hour exceeds 0.10%, it is preferable that the heat shrinkage is less than 0.10%.

Polymerization of the polyimide used in this disclosure can be accomplished by any commonly known method, e.g.:
(1) A polymerization method wherein, first, the entire quantity of the aromatic diamine ingredients is placed in a solvent, and then the aromatic tetracarboxylic acid ingredients are added to reach a quantity equivalent to the entire quantity of aromatic diamine ingredients.
(2) A polymerization method wherein, first, the entire quantity of the aromatic tetracarboxylic acid ingredients is placed in a solvent, and then the aromatic diamine ingredients are added to reach a quantity equivalent to the entire quantity of aromatic tetracarboxylic acid ingredients.
(3) A polymerization method wherein one of the aromatic diamine compounds is placed in a solvent, and then the aromatic tetracarboxylic acid compound is admixed to the reaction ingredients for the time required to reach a proportion of 95˜105 mol %, after which, the other aromatic diamine compound is added and then the aromatic tetracarboxylic acid compound is added so that the total amount of the aromatic diamine ingredient and the total amount of the aromatic tetracarboxylic acid compound are nearly equal.
(4) A polymerization method wherein the aromatic tetracarboxylic acid compound is placed in a solvent, and then one of the aromatic diamine compounds is admixed to the reaction ingredients for the time required to reach a proportion of 95˜105 mol %, after which, the aromatic tetracarboxylic acid compound is added then the other aromatic diamine compound is continued so that the total amount of the aromatic diamine ingredient and the total amount of the aromatic tetracarboxylic acid compound are nearly equal.
(5) A polymerization method wherein a polyamic acid solution (A) is prepared by causing one of the aromatic diamine ingredients and an aromatic tetracarboxylic acid to react in a solvent so there is a surplus of one or the other of them, and a polyamic acid solution (B) is prepared by causing the other of the aromatic diamine ingredients and an aromatic tetracarboxylic acid to react in a different solvent so there is a surplus of one or the other of them, and then the various resulting polyamic acid solutions (A) and (B) are mixed to complete polymerization. (At this time, if there is a surplus of the aromatic diamine ingredient when polyamic acid solution (A) is prepared, polyamic acid solution (B) is prepared so that there is a surplus of the aromatic tetracarboxylic acid ingredient, or if there is a surplus of the aromatic tetracarboxylic acid ingredient when polyamic acid solution (A) is prepared, polyamic acid solution (B) is prepared so that there is a surplus of the aromatic diamine ingredient, so that when the polyamic acid solutions (A) and (B) are combined, the total quantity of aromatic diamine ingredient and the total quantity of aromatic tetracarboxylic acid ingredient used in the reaction are nearly equal.), etc.
   Further, the polymerization method is not limited to these, and other commonly known methods may also be used. In addition, typical examples of organic solvents used in the formation of the polyamic acid solution in this disclosure can include, e.g., sulfoxide solvents such as dimethylsulfoxide and dimethylsulfoxide, etc., formamide solvents such as N,N-dimethylformamide and N,N-diethylformamide, etc., acetamide solvents such as N,N-dimethylacetamide and N,N-diethylacetamide, etc., pyrolidone solvents such as N-methyl-2-pyrolidone and N-vinyl-2-pyrolidone, etc., phenol solvents such as phenol, o-, m-, or p-creosol, xylenol, phenol halide, and catechol, etc. or non-protonic polar solvents such as hexamethylphosphoramide and γ-butyrolactone, etc., and it is preferable that these are used individually or as mixtures, but it is further possible to use aromatic hydrocarbons such as xylene and toluene, etc. For a stable slurry, it is preferred that the resulting polyamic acid solution contains 5˜40% by weight solids, preferably 10˜30% by weight, or has viscosity of 10˜2000 Pa·s, preferably 100˜1000 Pa·s, measured with a bulk field viscometer. In some embodiments, the polyamic acid in the organic solvent solution may also be partially imidized.

Methods of producing the polyimide film include a method wherein the polyamic acid solution is cast as a film and then thermally decyclized and the solvent evaporated to obtain a polyimide film, and a method wherein a gel film is produced by admixing a cyclization catalyst and dehumidifier to the polyamic acid solution to chemically cause decyclization, and then heat evaporating the solvent to obtain a polyimide film, but the latter is preferred as it is able to keep the coefficient of thermal expansion of the resulting polyimide film low.

In some embodiments, inorganic particles added in this disclosure to form protrusions in the polyimide film surface include SiO₂ (silica), TiO₂, CaHPO₄, and Ca₂P₂O₇, etc. but these must be insoluble in all of the chemical substances with which they will come in contact in the aforementioned polyimide film manufacturing processes. In some embodiments, the inorganic particle is silica manufactured by the sol-gel method or wet pulverization in this disclosure because it is stable in a polyamic acid varnish solution, it is physically stable, and it has no effect on any of the physical properties of the polyimide. Furthermore, it is preferable to use a silica slurry wherein ultrafine silica powder is uniformly dispersed in a polar solvent, such as N,N-dimethylformamide, N,N-dimethylacetamide, dimethylsulfoxide, or n-methylpyrolidone, etc., as it makes it possible to prevent agglutination. Because of its slow precipitation rate due to its extremely small grain size, this slurry is very stable. In addition, even if it does precipitate, it can be easily redispersed by remixing.

When the inorganic particles added to form the protrusions at the surface of the polyimide film in this disclosure have particle sizes within the range 0.01˜1.5 μm, and a mean particle size in the range of 0.05˜0.7 μm, preferably in the range of 0.1˜0.6 μm, and more preferably in the range of 0.3˜0.5 μm, automatic optical inspection systems can be employed for inspection without any problem. It can also be used without causing a decrease in any of the mechanical properties, etc. of the polyimide film. Conversely, if the mean particle size is below than these ranges, adequate slip will not be obtained in the film, and if it is above, the inorganic particles will be recognized as debris by the automatic inspection system and will cause damage, so that neither is preferable. Further, since the film is normally 5 μm˜175 μm, the inorganic particles within this particle size range will not be exposed at the film surface.

The quantity of inorganic particles added comprises a percent of 0.1˜0.9% by weight per unit weight of film resin, preferably 0.3˜0.8% by weight. It is undesirable for this to be less than 0.1% by weight, as sufficient slip will not be rendered in the film due to the insufficient number of protrusions at the film surface, which in turn deteriorates the transportability and worsens the film wrapping profile when wound onto a roll. Conversely, it is undesirable for it to exceed 0.9% by weight as, while this improves slip, it increases coarse protrusions due to abnormal agglutination of the particles, resulting in their being recognized as debris by automatic inspection systems and causing damage.

In some embodiments, the grain size distribution in the inorganic particles is a narrow distribution, i.e., that a higher percentage of all the particles is made up of similarly sized particles, and concretely that particles with a grain size of 0.15˜0.60 μm comprise at least 80% by volume of all the particles. It is undesirable for particles smaller than 0.15 μm below this range to make up a higher percentage of the particles, as it decreases the slip of the film. It is also possible to remove the coarser particles from the inorganic particle slurry with a 5 μm cut filter or 10 μm cut filter, but it is undesirable for there to be a high percentage of particles over 0.60 μm, as the filter will frequently clog, not only sacrificing process stability, but also making it susceptible to agglutination of large particles.

In some embodiments, the number of protrusions, resulting from the inorganic particles, over 2 μm high occur 5 times or less in an area of 40 cm². In another embodiment, the number of protrusions, resulting from the inorganic particles, over 2 μm high occur 3 times or less in a area of 40 cm². In another embodiment, the number of protrusions, resulting from the inorganic particles, over 2 μm high occur 1 times or less in a area of 40 cm². It is undesirable that there are more than this as the inorganic particles will be recognized as debris by the automatic inspection system, and will cause damage.

It is preferred that the polyimide film is obtained by adding a slurry, in which this kind of inorganic particle is dispersed in the same polar solvent as the organic solvent used to manufacture the polyimide, to the polyamic acid solution in the polyimide manufacturing process, and then performing decyclizing and solvent evaporation, but it is also possible add the inorganic particle slurry in any process as long as it is a process prior to decyclization and solvent evaporation, e.g., adding the inorganic particle slurry to the organic solvent before polymerization of the polyamic acid, and then polymerizing the polyamic acid, and finally performing decyclization and solvent evaporation, etc.

The thickness of the polyimide film is not specifically limited in the copper clad laminate of this disclosure, but it is preferably 5˜175 μm, more preferably 9˜75 μm, and even more preferably 11˜55 μm. If it is too thick, it becomes susceptible to winding defects when it is wound into a roll, and conversely, if it is too thin, it tends to be susceptible to streaking, etc.

The copper foil laminate is directly formed on one side of the above kind of polyimide film without adhesive by metalizing, etc. and a copper laminate is formed on the other side by means of an adhesive. It is preferred that copper foil is used as the copper laminate that is attached to one side of the polyimide film with an adhesive. It is preferable that the copper foil used in this disclosure is one in which the surface roughness (Rz) of the copper is 0.1˜10 μm on the adhesive side. If the surface roughness is coarser than this, it becomes difficult to current to flow due to the skin effect when used as flexible printed circuit board in a high-frequency signal area, making it difficult to use in a high-frequency area. The surface roughness (Rz) referred to here is the Rz stipulated in JISB 0601-1994 “Definition and Expression of Surface Roughness,” 5.1 “Definition of 10-point Mean Roughness.”

In some embodiments, the adhesive used when adhering the copper laminate with adhesive is at least one selected from epoxy adhesives, acrylic adhesives, and polyimide adhesives. A variety of other additives, such as various rubbers, plasticizers, curing agents, phosphoric or other flame retarders, etc., may also be added for the purpose of providing flexibility. In addition, thermoplastic polyimides are often used primarily as the resin ingredient in polyimide adhesives, but thermosetting polyimides may also be used. In some embodiments, a thermoplastic polyimide film is used as the adhesive.

It is preferred that the percent dimensional change after fully etching both surfaces of the copper clad laminate is within the range of −0.100%˜0.100%, more preferably within the range 0.05%˜0.05%, and even more preferably in within the range −0.03%˜0.03%, so problems do not arise during mounting as a flexible printed circuit board. Since it has a low percent dimensional change after etching and possesses characteristics that are applicable to AOI, and due to its superior mobility (slip) and adhesion, a copper clad laminate thus constituted makes it possible to form intricate wiring patterns, and because mobility and adhesion are improved, without deformation even when lead-free solder is used, it is extremely useful as a raw material for high-performance flexible circuit boards (FPC) and chips-on-film (COF), etc. on which intricate wiring patterns are formed.

Consequently, because it makes it possible to form intricate wiring patterns, and can improve mobility and adhesion, without deforming even when lead-free solders are used, the copper clad laminate of this disclosure is very useful as a raw material for flexible printed circuit boards (FPC) and chips-on-film (COF), etc., on which intricate wiring patterns are formed. In addition, since it possesses a copper laminate attached by means of an adhesive on one side and a copper laminate attached by means other than adhesive on the other side, it is also optimal for use as a multilayer laminate.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

### EXAMPLES

The invention will be further described in the following examples, which do not limit the scope of the invention described in the claims.

The various characteristics of the polyimide films obtained in the embodiments and the copper clad laminates of the embodiments were evaluated by the following methods.

### (1) Film Thickness

Measured using a Mitsutoyo Lightmatic (Series 318).

### (2) Coefficient of Friction (Static Friction Coefficient)

Treated surfaces of film are stacked one on another and measured based on JIS K-7125 (1999). Namely, Using a Slip Tester slip coefficient analyzer (Techno Needs Co., Ltd.), treated film surfaces are stacked one on another, a 200 g weight is placed on top of them, one of the films is secured, the other is pulled at 100 mm/min, and the coefficient of friction is measured.

### (3) Automatic Optical Inspection (AOI)

The base film was inspected using a Orbotech SK-75. When there was a distinction made between debris and microparticles it was evaluated as “◯,” while if the sizes of debris and microparticles were similar and no distinction could be made between the two, it was evaluated as “×.”

### (4) Evaluation of Inorganic Particles

The grain size range, mean grain size, and percentage of all particles comprised of 0.15˜0.60 μm grains were read from the results of measuring and analyzing samples dispersed in a polar solvent using a Horiba Ltd. LA-910 laser scattering particle size distribution analyzer.

### (5) Abnormal Protrusion Count

The number of protrusions over 2 μm high was counted per 40 cm² surface area of film. Height was measured using a Nikon 100× lens (CF Plan 100×/0.95 ∞/0 EPI) on a Laser Tech “1LM15W” scanning laser microscope, by photographing and analyzing the film surface in “SURFACE 1” mode.

### (6) Percent Dimensional Change

The percent dimensional change before and after etching the copper clad laminate was measured using a CNC image processing measurement system (Nikon, NEXIV VMR-3020) under conditions of 25° C. temperature and 60% humidity, by setting the field to 1.165 mm×0.875 mm (4×) and measuring, before and after etching the entire copper surface, the distance between the centers of two 6 mmφ round masking tape circles adhered to the surface of the copper clad laminate at a distance of 210 mm in the MD direction and then making calculations. Before measuring, both before and after copper etching, the sample was left overnight under conditions of 25° C. temperature and 60% humidity to eliminate the effects absorbed water in the polyimide. The percent dimensional change was calculated by the following equation using the mean value from measuring the distance between the two points 5 times.

Percent dimensional change (%)=(Distance before etching−Distance after etching)/Distance before etching×100

### COMPOSITION EXAMPLE 1

50 parts by weight Yuka Shell “Epikote” 828 epoxy resin, 100 parts by weight Tohto Kasei (Ltd.) FX279BEK75 phosphorus-modified epoxy resin, 6 parts by weight Sumitomo Chemical (Ltd.) 4,4′-DDS curing agent, 100 parts by weight JSR (Ltd.) NBR (PNR-1H), 30 parts by weight Showa Denko (Ltd.) aluminum hydroxide, and 600 parts by weight methylisobutylketone were stirred and mixed at 30° C. to yield an adhesive solution.

### COMPOSITION EXAMPLE 2

50 parts by weight Yuka Shell “Epicote” 828 epoxy resin, 80 parts by weight Tohto Kasei (Ltd.) FX279BEK75 phosphorus-modified epoxy resin, 6 parts by weight Sumitomo Chemical (Ltd.) 4,4′-DDS curing agent, 100 parts by weight JSR (Ltd.) NBR (PNR-1H), 10 parts by weight Showa Denko (Ltd.) aluminum hydroxide, and 600 parts by weight methylisobutylketone were stirred and mixed at 30° C. to yield an adhesive solution.

### Example Embodiment 1

Pyromellitic dianhydride/3,3′,4,4′-biphenyltetracarboxylic dianhydride/4,4′-diaminodiphenylether/paraphenylenediamine was prepared at a mol ratio of 65/35/80/20, and polymerized in DMAc (N,N-dimethylacetoamide) to yield an 18.5% by weight solution of polyamic acid

At this point, a N,N-dimethylacetoamide slurry of silica, with grain size greater than 0.01 μm and less than 1.5 μm, mean grain size of 0.30 μm, and 87.2% by volume of all grains made up of grains with grain size 0.15˜0.60 μm, was added to the aforementioned polyamic acid solution to 0.3% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 25 μm-thick polyimide film.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nickel chrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, the adhesive of Composition Example 1 was applied to the polyimide surface on the other side and heat-dried at 150° C.×5 minutes to form a 10 μm-dried film thickness adhesive layer.

This one-sided, adhesive-backed copper clad laminate and a 1.5 μm, ½-ounce copper foil (Furukawa Circuit Foil (Ltd.), F0-WS18), with 1.5 μm surface roughness (Rz), were hot laminated using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.009%.

The results of the other characteristic evaluations are shown compiled in Table 1.

### Example Embodiment 2

Pyromellitic dianhydride/3,3′,4,4′-biphenyltetracarboxylic dianhydride/4,4′-diaminodiphenylether/paraphenylenediamine was prepared at a mol ratio of 65/35/80/20, and polymerized in DMAc (N,N-dimethylacetoamide) to yield an 18.5% by weight solution of polyamic acid.

At this point, a N,N-dimethylacetoamide slurry of silica, with grain size greater than 0.01 μm and less than 1.5 μm, mean grain size of 0.35 μm, and 86.3% by volume of all grains made up of grains with grain size 0.15˜0.60 μm, was added to the aforementioned polyamic acid solution to 0.35% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 38 μm-thick polyimide film.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm2 current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, the adhesive of Composition Example 1 was applied to the polyimide surface on the other side and heat-dried at 150° C.×5 minutes to form a 10 μm-dried film thickness adhesive layer. This one-sided, adhesive-backed copper clad laminate and a 1.5 μm, ½-ounce copper foil (Furukawa Circuit Foil (Ltd.), F0-WS18), with 1.5 μm surface roughness (Rz), were hot laminated using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.013%.

The results of the other characteristic evaluations are shown compiled in Table 1.

### Example Embodiment 3

Pyromellitic dianhydride/3,3′,4,4′-biphenyltetracarboxylic dianhydride/4,4′-diaminodiphenylether/paraphenylenediamine was prepared at a mol ratio of 3/1/3/1, and polymerized in DMAc (N,N-dimethylacetoamide) to yield an 18.5% by weight solution of polyamic acid.

At this point, a N,N-dimethylacetoamide slurry of silica, with grain size greater than 0.01 μm and less than 1.5 μm, mean grain size of 0.45 μm, and 87.7% by volume of all grains made up of grains with grain size 0.15˜0.60 μm, was added to the aforementioned polyamic acid solution to 0.3% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 25 μm-thick polyimide film.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, the adhesive of Composition Example 1 was applied to the polyimide surface on the other side and heat-dried at 150° C.×5 minutes to form a 10 μm-dried film thickness adhesive layer. This one-sided, adhesive-backed copper clad laminate and a 1.5 μm, ½-ounce copper foil (Furukawa Circuit Foil (Ltd.), F0-WS18), with 1.5 μm surface roughness (Rz), were hot laminated using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.003%.

The results of the other characteristic evaluations are shown compiled in Table 1.

### Example Embodiment 4

Pyromellitic dianhydride/3,3′,4,4′-biphenyltetracarboxylic dianhydride/4,4′-diaminodiphenylether/paraphenylenediamine was prepared at a mol ratio of 4/1/4/1 to yield a polyamic acid.

At this point, a N,N-dimethylacetoamide slurry of silica, with grain size greater than 0.01 μm and less than 1.5 μm, mean grain size of 0.35 μm, and 87.0% by volume of all grains made up of grains with grain size 0.15˜0.60 μm, was added to the aforementioned polyamic acid solution to 0.5% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 12.5 μm-thick polyimide film.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, the adhesive of Composition Example 2 was applied to the polyimide surface on the other side and heat-dried at 150° C.×5 minutes to form a 10 μm-dried film thickness adhesive layer. This one-sided, adhesive-backed copper clad laminate and a 1.5 μm, ½-ounce copper foil (Furukawa Circuit Foil (Ltd.), F0-WS18), with 1.5 μm surface roughness (Rz), were hot laminated using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.045%.

The results of the other characteristic evaluations are shown compiled in Table 1.

### Example Embodiment 5

Pyromellitic dianhydride/3,3′,4,4′-biphenyltetracarboxylic dianhydride/4,4′-diaminodiphenylether/paraphenylenediamine was prepared at a mol ratio of 9/1/8/2 to yield a polyamic acid.

At this point, a N,N-dimethylacetoamide slurry of silica, with grain size greater than 0.01 μm and less than 1.5 μm, mean grain size of 0.37 μm, and 86.5% by volume of all grains made up of grains with grain size 0.15˜0.60 μm, was added to the aforementioned polyamic acid solution to 0.5% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 7.5 μm-thick polyimide film.

In a vacuum tank that had been brought to 1×10⁻³ Pa final pressure and then pressurized with argon gas to 1×10⁻¹ Pa, one side of this polyimide film was then sputtered with a nickel/chromium (95/5 weight ratio) alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, the adhesive of Composition Example 2 was applied to the polyimide surface on the other side and heat-dried at 150° C.×5 minutes to form a 10 μm-dried film thickness adhesive layer. This one-sided, adhesive-backed copper clad laminate and a 1.5 μm, ½-ounce copper foil (Furukawa Circuit Foil (Ltd.), F0-WS18), with 1.5 μm surface roughness (Rz), were hot laminated using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.007%.

The results of the other characteristic evaluations are shown compiled in Table 1.

### Example Embodiment 6

Pyromellitic dianhydride/3,3′,4,4′-biphenyltetracarboxylic dianhydride/4,4′-diaminodiphenylether/paraphenylenediamine was prepared at a mol ratio of 3/2/3/2 to yield a polyamic acid.

At this point, a N,N-dimethylacetoamide slurry of silica, with grain size greater than 0.01 μm and less than 1.5 μm, mean grain size of 0.52 μm, and 86.8% by volume of all grains made up of grains with grain size 0.15˜0.60 μm, was added to the aforementioned polyamic acid solution to 0.5% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 50 μm-thick polyimide film.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, the adhesive of Composition Example 1 was applied to the polyimide surface on the other side and heat-dried at 150° C.×5 minutes to form a 10 μm-dried film thickness adhesive layer. This one-sided, adhesive-backed copper clad laminate and a 1.5 μm, ½-ounce copper foil (Furukawa Circuit Foil (Ltd.), F0-WS18), with 1.5 μm surface roughness (Rz), were hot laminated using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.009%.

The results of the other characteristic evaluations are shown compiled in Table 1.

### Example Embodiment 7

Pyromellitic dianhydride/3,3′,4,4′-biphenyltetracarboxylic dianhydride/4,4′-diaminodiphenylether/paraphenylenediamine was prepared at a mol ratio of 3/2/3/2 to yield a polyamic acid.

At this point, a N,N-dimethylacetoamide slurry of silica, with grain size greater than 0.01 μm and less than 1.5 μm, mean grain size of 0.42 μm, and 87.7% by volume of all grains made up of grains with grain size 0.15˜0.60 μm, was added to the aforementioned polyamic acid solution to 0.5% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 125 μm-thick polyimide film.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, an acrylic polyimide adhesive (DuPont Pyralux LF010) was applied to the polyimide surface on the other side and hot laminated with a 1.5 μm, ½-ounce copper foil (Furukawa Circuit Foil (Ltd.), F0-WS18), with 1.5 μm surface roughness (Rz), using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.011%.

The results of the other characteristic evaluations are shown compiled in Table 1.

### Example Embodiment 8

Pyromellitic dianhydride/3,3′,4,4′-biphenyltetracarboxylic dianhydride/4,4′-diaminodiphenylether/paraphenylenediamine was prepared at a mol ratio of 3/2/3/2 to yield a polyamic acid.

At this point, a N,N-dimethylacetoamide slurry of silica, with grain size greater than 0.01 μm and less than 1.5 μm, mean grain size of 0.42 μm, and 87.7% by volume of all grains made up of grains with grain size 0.15˜0.60 μm, was added to the aforementioned polyamic acid solution to 0.5% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 175 μm-thick polyimide film.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, an acrylic polyimide adhesive (DuPont Pyralux LF010) was applied to the polyimide surface on the other side and hot laminated with a 1.5 μm, ½-ounce copper foil (Furukawa Circuit Foil (Ltd.), F0-WS18), with 1.5 μm surface roughness (Rz), using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.014%.

The results of the other characteristic evaluations are shown compiled in Table 1.

TABLE 1

| | Example Embodiments | | | | | | | |
|---|---|---|---|---|---|---|---|---|
| | 1 | 2 | 3 | 4 | 5 | 6 | 7 | 8 |
| Grain size | 0.01~1.5 | 0.01~1.5 | 0.01~1.5 | 0.01~1.5 | 0.01~1.5 | 0.01~1.5 | 0.01~1.5 | 0.01~1.5 |
| range (μm) | | | | | | | | |
| Mean grain | 0.30 | 0.38 | 0.45 | 0.35 | 0.37 | 0.52 | 0.42 | 0.42 |
| size (μm) | | | | | | | | |
| Quantity | 0.30 | 0.35 | 0.30 | 0.50 | 0.80 | 0.30 | 0.40 | 0.40 |
| added (wt %) | | | | | | | | |
| Percent grain | 87.2 | 86.3 | 87.7 | 87.0 | 86.5 | 86.8 | 87.7 | 87.7 |
| size | | | | | | | | |
| 0.15~0.60 μm | | | | | | | | |
| (vol %) | | | | | | | | |
| Film | 38 | 38 | 25 | 13 | 8 | 59 | 125 | 175 |
| thickness | | | | | | | | |
| (μm) | | | | | | | | |
| Coef of static | 0.56 | 0.5 | 0.54 | 0.52 | 0.58 | 0.46 | 0.52 | 0.54 |
| friction | | | | | | | | |
| AOI | ◯ | ◯ | ◯ | ◯ | ◯ | ◯ | ◯ | ◯ |
| Abnormal | 0 | 0 | 1 | 0 | 0 | 0 | 0 | 0 |
| protrusions | | | | | | | | |
| (count) | | | | | | | | |
| Percent | 0.009 | 0.013 | 0.003 | 0.045 | 0.007 | −0.009 | 0.11 | 0.014 |
| dimensional | | | | | | | | |
| change (%) | | | | | | | | |

### COMPARISON EXAMPLE 1

Pyromellitic dianhydride/4,4′-diaminodiphenylether were mixed at a mol ratio of 50/50 and polymerized in DMF (N,N-dimethylformamide) to yield an 18.5% by weight solution of polyamic acid. A converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively.

The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 38 μm-thick polyimide film. This film had a high coefficient of static friction and poor slip.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, the adhesive of Composition Example 1 was applied to the polyimide surface on the other side and heat-dried at 150° C.×5 minutes to form a 10 μm-dried film thickness adhesive layer. This one-sided, adhesive-backed copper clad laminate and a 1.5 μm, ½-ounce copper foil (Furukawa Circuit Foil (Ltd.), F0-WS18), with 1.5 μm surface roughness (Rz), were hot laminated using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.125%.

The results of the other characteristic evaluations are shown compiled in Table 2.

### COMPARISON EXAMPLE 2

Pyromellitic dianhydride/4,4′-diaminodiphenylether were mixed at a mol ratio of 50/50 and polymerized in DMF (N,N-dimethylformamide) to yield an 18.5% by weight solution of polyamic acid.

At this point, a N,N-dimethylacetoamide slurry of dibasic calcium phosphate, with grain size greater than 0.1 μm and less than 4.5 μm, mean grain size of 1.1 μm, and 27.3% by volume of all grains made up of grains with grain size 0.15˜0.60 μm, was added to the aforementioned polyamic acid solution to 0.2% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively.

The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 38 μm-thick polyimide film. This film had manifested a large number of abnormal projections and AOI inspection was unable to distinguish between debris and microparticles. In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, the adhesive of Composition Example 1 was applied to the polyimide surface on the other side and heat-dried at 150° C.×5 minutes to form a 10 μm-dried film thickness adhesive layer. This one-sided, adhesive-backed copper clad laminate and a 1.5 μm, ½-ounce copper foil (Furukawa Circuit Foil (Ltd.), F0-WS18), with 1.5 μm surface roughness (Rz), were hot laminated using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.115%.

The results of the other characteristic evaluations are shown compiled in Table 2.

### COMPARISON EXAMPLE 3

Pyromellitic dianhydride/3,3′,4,4′-biphenyltetracarboxylic dianhydride/4,4′-diaminodiphenylether/paraphenylenediamine was prepared at a mol ratio of 65/35/80/20, and polymerized in DMAc (N,N-dimethylacetoamide) to yield an 18.5% by weight solution of polyamic acid At this point, a N,N-dimethylacetoamide slurry of silica, with grain size greater than 0.01 μm and less than 3.0 μm, mean grain size of 0.08 μm, and 31.4% by volume of all grains made up of grains with grain size 0.15˜0.60 μm, was added to the aforementioned polyamic acid solution to 0.35% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 38 μm-thick polyimide film. This film had a high coefficient of static friction and poor slip.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, the adhesive of Composition Example 2 was applied to the polyimide surface on the other side and heat-dried at 150° C.×5 minutes to form a 10 μm-dried film thickness adhesive layer. This one-sided, adhesive-backed copper clad laminate and a 1.5 μm, ½-ounce copper foil (Furukawa Circuit Foil (Ltd.), F0-WS18), with 1.5 μm surface roughness (Rz), were hot laminated using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.014%.

The results of the other characteristic evaluations are shown compiled in Table 2.

### COMPARISON EXAMPLE 4

Pyromellitic dianhydride/3,3′,4,4′-biphenyltetracarboxylic dianhydride/4,4′-diaminodiphenylether/paraphenylenediamine was prepared at a mol ratio of 65/35/80/20, and polymerized in DMAc (N,N-dimethylacetoamide) to yield an 18.5% by weight solution of polyamic acid.

At this point, a N,N-dimethylacetoamide slurry of silica, with grain size greater than 0.01 μm and less than 1.5 μm, mean grain size of 0.4 μm, 22.3% by volume of all grains made up of grains with grain size 0.9˜1.3 μm, and 72.6% by volume of all grains made up of grains with grain size 0.15˜0.60 μm, was added to the aforementioned polyamic acid solution to 0.35% by weight per unit weight of resin, thoroughly stirred and dispersed, after which a converter made from acetic anhydride (molecular weight 102.09) and isoquinoline was mixed into the polyamic acid solution at a percentage of 50% by weight and stirred. The preparation at this time was such that the mol equivalents of acetic anhydride and isoquinoline to amidic acid groups in the polyamic acid were 2.0 and 0.4, respectively. The resulting mixture was cast through a T-shaped slit die onto a rotating 100° C. stainless steel drum to yield an approximately 0.20 mm-thick, self-supporting gel film with 55% by weight residual volatiles. This gel film was peeled off the drum, both ends were clamped and it was treated in a heating furnace at 200° C.×30 seconds, 350° C.×30 seconds, and 550° C.×30 seconds to yield a 38 μm-thick polyimide film. This film had manifested a large number of abnormal projections. In addition, AOI inspection was unable to distinguish between debris and microparticles.

In a vacuum tank that had been brought to 1×10⁻³ Pa final pressure and then pressurized with argon gas to 1×10⁻¹ Pa, one side of this polyimide film was then sputtered with a nickel/chromium=95/5 (weight ratio) nichrome alloy to a thickness of 5 nm by DC magnetron sputtering, and then copper was sputtered to a thickness of 50 nm. Next, a 6 μm-thick copper layer was laminated by electroplating in a copper sulfate bath, under conditions of 2 A/dm² current density to produce a one-sided copper clad laminate. Further, the composition of the copper sulfate bath used a solution in which suitable quantities of additives were added to 80 g/liter copper sulfate pentahydrate, 200 g/liter sulfuric acid, and 50 g/liter hydrochloric acid. After drying, an acrylic polyimide adhesive (DuPont Pyralux LF010) was applied to the polyimide surface on the other side and hot laminated with a 1.5 μm, ½-ounce copper foil (Furukawa Circuit Foil (Ltd.), F0-WS18), with 1.5 μm surface roughness (Rz), using a hot roll laminator, under conditions of 160° C. laminating temperature, 196 N/cm (20 kgf/cm) laminating pressure, and 1.5 m/minute laminating speed, to produce a two-sided flexible copper clad laminate.

When the percent dimensional change before and after etching the entire copper surface was measured using the resulting copper clad laminate, the percent dimensional change was 0.016%.

The results of the other characteristic evaluations are shown compiled in Table 2.

TABLE 2

| | Comparison Examples | | | |
|---|---|---|---|---|
| | 1 | 2 | 3 | 4 |
| Grain size range (μm) | — | 0.1~4.5 | 0.01~3.0 | 0.01~1.5 |
| Mean grain size (μm) | — | 1.1 | 0.08 | 0.4 |
| Quantity added (wt %) | — | 0.2 | 0.35 | 0.35 |
| Percent grain size | — | 27.3 | 31.4 | 72.6 |
| 0.15~0.60 μm (vol %) | | | | |
| Film thickness (μm) | 38 | 38 | 38 | 38 |
| Coef of static friction | 2.28 | 0.48 | 0.98 | 0.51 |
| AOI | ◯ | X | Δ | Δ |
| Abnormal protrusions (count) | 0 | 8 | 0 | 4 |
| Percent dimensional change | −0.125 | −0.115 | −0.014 | 0.016 |
| (%) | | | | |

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

When an amount, concentration, or other value or parameter is given as either a range, preferred range or a list of upper values and lower values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

What is claimed is:

1. A copper clad laminate comprising a polyimide film, the polyimide film comprising:
A. an aromatic diamine component derived from:
i. 10-50 mol % paraphenylenediamine;
ii. 50-90 mol % 4,4′-diaminodiphenyl ether; and
B. an aromatic tetracarboxylic acid component derived from:
i. 50-99 mol % pyromellitic dianhydride; and
ii. 1-50 mol % 3,3′,4,4′-biphenyl tetracarboxylic acid dianhydride
wherein the polyimide film contains inorganic particles having a grain size of 0.01 μm to 1.5 μm, wherein the mean grain size is from 0.05 μm to 0.7 μm, and wherein at least 80% by volume of the inorganic particles-have a grain size from 0.15 to 0.60 μm;
wherein a copper foil is adhered to one side of the polyimide film using an adhesive; and
wherein a second copper foil is directly adhered to the second side of the polyimide film.

2. A copper clad laminate in accordance with claim 1 wherein the copper foil on the adhesive side has a surface roughness from 0.1 to 10 μm.

3. A copper clad laminate in accordance with claim 1 wherein the dimensional change after surface etching is from −0.100% to 0.100%
